(19) United States
(12) Patent Application Publication
(10) Pub. No.: US 2018/0274964 A1
(43) Pub. Date: Sep. 27, 2018

(54) PHYSICAL QUANTITY SENSOR SUBASSEMBLY AND PHYSICAL QUANTITY MEASURING DEVICE

(71) Applicant: DENSO CORPORATION, Kariya-city, Aichi-pref (JP)

(72) Inventors: Junzo YAMAGUCHI, Kariya-city (JP); Hironao YAMAGUCHI, Kariya-city (JP)

(21) Appl. No.: 15/763,247

(22) PCT Filed: Sep. 9, 2016
(86) PCT No.: PCT/JP2016/076609

§ 371 Date: Mar. 26, 2018

(30) Foreign Application Priority Data
Oct. 16, 2015 (JP) 2015-204272

(51) Int. Cl. G01F 15/14

(52) U.S. Cl. CPC G01F 15/14; G01N 27/223

(57) ABSTRACT

The physical quantity sensor subassembly has a preformed part, a wiring member, and an outer resin portion. The preformed part includes a physical quantity sensing element configured to detect a physical quantity other than a flow rate of the gas to be measured, a wiring terminal electrically connected to the physical quantity sensing element, a concave portion in which the gas to be measured is introduced, and an inner resin portion is molded around the physical quantity sensing element and the wiring terminal to be integral with the physical quantity sensing element and the wiring terminal. A sensing surface is exposed at the concave portion. The wiring member is electrically connected to the wiring terminal of the preformed part. An outer resin portion includes an opening hole portion communicating with the concave portion, and is molded around the preformed part, the wiring member, and an electrically connected portion between the preformed part and the wiring member.

### CROSS REFERENCE TO RELATED APPLICATION

The present application is based on Japanese Patent Application No. 2015-204272 filed on Oct. 16, 2015, disclosure of which is incorporated herein by reference.

### TECHNICAL FIELD

The present disclosure relates to a physical quantity sensor subassembly and a physical quantity measuring device.

### BACKGROUND ART

Conventionally, there has been known a physical quantity measuring device that measures the physical quantity relating to a gas to be measured such as air. The physical quantity measuring device has a physical quantity sensor subassembly which supports the physical quantity sensing element. For example, in the structure of the physical quantity sensor subassembly, a wiring terminal in a pre-molded part in which a physical quantity sensing element is resin-molded is electrically connected to a wiring of a board on which the preformed part is placed by soldering, and the board on which the preformed part is mounted is supported to a casing. In the physical quantity measuring device, in order to generate a necessary detection signal, the physical quantity sensing element has to be exposed to the gas to be measured.

Prior patent literature 1 discloses an air physical quantity measuring device for measuring a flow rate and a humidity of intake air flowing in an intake passage of an internal combustion engine. This patent literature discloses that the surface of the electronic circuit board for a humidity sensor is protected by using a coating member, after the electronic circuit board for the humidity sensor and the connector terminal for the humidity sensor are electrically connected to each other with a metal wire.

### PRIOR ART LITERATURES

### Patent Literature

Patent Literature 1: Japanese Patent No. 5675717

### SUMMARY OF INVENTION

However, in the above-described physical quantity sensor subassembly, minute impurities, water droplets, or the like which cause contamination of the sensor contained in the gas to be measured tend to adhere to the electrical connecting portion between the wiring terminal of the preformed part and the substrate. If the impurities, the water droplets or the like adhere to the electrical connecting portion, there is a possibility that the measurement precision deteriorates or a short circuit between the terminals or the like is caused due to an increase of the leakage current or the like. Therefore, in order to protect the electrical connecting portion, it is necessary to perform so-called resin potting, in which a gap formed around the electrical connecting portion is filled with a resin such as epoxy resin and sealed.

However, the resin potting requires a step of hardening the poured resin. Thus, the manufacturing process of the physical quantity sensor subassembly becomes complicated. Further, since the casing for holding the physical quantity sensor subassembly having the above-described structure is additionally required, the number of parts also increases.

The present disclosure has a purpose to provide a physical quantity sensor subassembly capable of improving environmental resistance, simplifying a manufacturing process, and reducing the number of parts, and to provide a physical quantity measuring device using the physical quantity sensor subassembly.

In one exemplary aspect of the present disclosure, the physical quantity sensor subassembly has a preformed part and an outer resin portion. The preformed part includes a physical quantity sensing element configured to detect a physical quantity other than a flow rate of the gas to be measured, a wiring terminal electrically connected to the physical quantity sensing element, a concave portion in which the gas to be measured is introduced, and an inner resin portion molded around the physical quantity sensing element and the wiring terminal to be integral with the physical quantity sensing element and the wiring terminal. A sensing surface of the physical quantity sensing element is exposed at the concave portion. The outer resin portion includes a wiring member electrically connected to the wiring terminal of the preformed part, and the opening hole portion communicating with the concave portion. The outer resin portion is molded around the preformed part, the wiring member, and an electrically connected portion between the preformed part and the wiring member to be integral with the preformed part, the wiring member, and the electrically connected portion.

In other exemplary aspect of the present disclosure, the physical quantity device has a flow rate measuring portion configured to measure the flow rate of the gas to be measured, a physical quantity measuring portion configured to measure the physical quantity other than the gas to be measured. The physical quantity measuring portion includes the physical quantity sensor subassembly.

According to the physical quantity sensor subassembly, the electrical connection portion between the preformed part and the wiring member is protected by the outer resin portion. Therefore, the physical quantity sensor subassembly can avoid the impurities, the water droplets, and the like contained in the gas to be measured from adhering to the electrically connected portion, thereby improving the environmental resistance.

Also, the physical quantity sensor subassembly does not require resin potting. Therefore, the physical quantity sensor subassembly can simplify the manufacturing process.

Further, in the physical quantity sensor subassembly, the outer resin portion can serve not only as protection of the electrical connection portion but also as a casing for holding the wiring member on which the preformed part is mounted. Therefore, the physical quantity sensor subassembly can reduce the number of parts, since the casing becomes unnecessary. Therefore, in the physical quantity sensor subassembly, since it is unnecessary to manufacture the casing, to assemble to the casing, etc., the manufacturing process can be simplified. Therefore, the physical quantity sensor subassembly is advantageous in cost reduction.

According to the above physical quantity measuring device, since the environmental resistance can be improved by the physical quantity sensor subassembly, the flow rate of the gas to be measured and the physical quantity other than the flow rate of the gas to be measured can be accurately measured. In addition, the above physical quantity measuring device can simplify the manufacturing process and reduce the number of parts.

It is to be noted that reference numerals in parentheses described in the claims indicate correspondence relationships with specific means described in embodiments described later and do not limit the technical scope of the present disclosure.

### BRIEF DESCRIPTION OF DRAWINGS

The above object and other objects, features, and advantages of the present disclosure will become more apparent from the following detailed description with reference to the accompanying drawings.

FIG. 1 is a diagram illustrating a schematic front view of a physical quantity sensor subassembly in a first embodiment;

FIG. 2 is a diagram illustrating a cross sectional view taken along line II-II in FIG. 1;

FIG. 3 is a diagram illustrating an enlarged view of a part in FIG. 2;

FIG. 4 is a diagram illustrating a schematic view of a physical quantity sensor subassembly in a second embodiment corresponding to FIG. 2;

FIG. 5 is a diagram illustrating a schematic view of a physical quantity sensor subassembly in a third embodiment corresponding to FIG. 2;

FIG. 6 is a diagram illustrating a schematic view of a physical quantity sensor subassembly in a fourth embodiment corresponding to FIG. 2;

FIG. 7 is a diagram illustrating a schematic explanatory view of a state in which the physical quantity measuring device in a fifth embodiment having the physical quantity sensor subassembly in the first embodiment is attached to a gas flow path as viewed from an upstream side in the flow direction of the gas to be measured with reference to a mounting position; and

FIG. 8 is a diagram schematically showing an inside of the physical quantity measuring device in the fifth embodiment.

### EMBODIMENTS FOR CARRYING OUT INVENTION

### First Embodiment

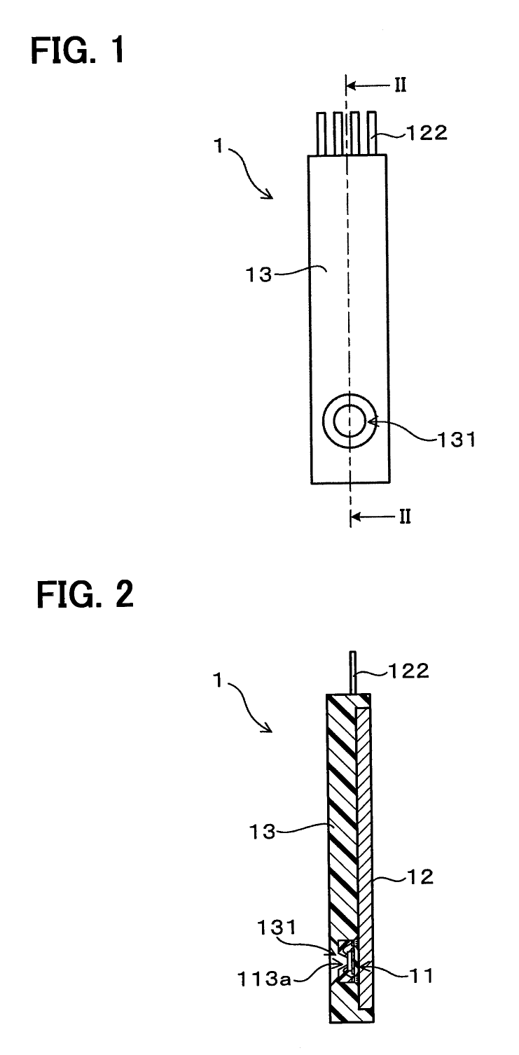

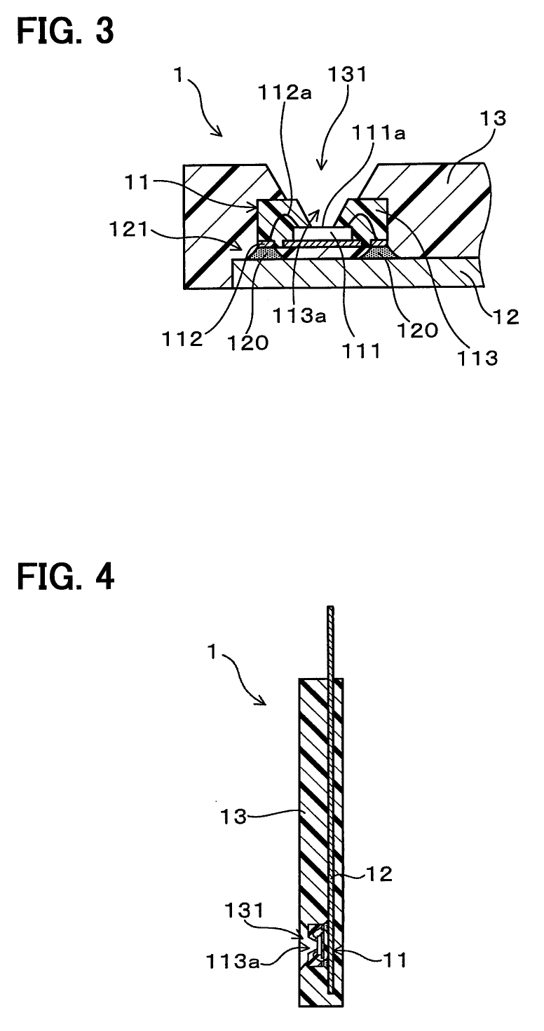

The physical quantity sensor subassembly in the first embodiment is explained with reference to FIGS. 1 to 3. As shown in FIGS. 1 to 3, the physical quantity sensor subassembly in the present embodiment has a preformed part 11, a wiring member 12, and an outer resin portion 13.

The preformed part 11 has a physical quantity sensing element 111, a wiring terminal 112, and an inner resin portion 113.

The physical quantity sensing element 111 in the preformed part 11 detects the physical quantity other than a flow rate of a gas to be measured. In particular, the gas to be measured is, for example, an intake air flowing in an intake air passage of the internal combustion engine. In this case, the physical quantity sensor subassembly 1 can have an resistance to the impurities, the water droplets, and the like contained in the intake air. As the physical quantity other than the flow rate of the gas to be measured, at least one of humidity, temperature, and pressure can be selected. In this case, by providing a physical quantity measuring unit including a physical quantity sensor subassembly in the physical quantity measuring device having the flow rate measuring unit for measuring the flow rate of the gas to be measured, it is possible to measure not only the flow rate of the gas to be measured but also the humidity, temperature, and pressure, or a combination thereof. Details will be described in the fifth embodiment. More specifically, examples of the physical quantities other than the flow rate of the gas to be measured include humidity, humidity and temperature, pressure, pressure and temperature, and the like.

In the present embodiment, the physical quantity sensing element 111 is formed in a chip shape, and detects the humidity of the gas to be measured. Specifically, the physical quantity sensing element 111 is a sensor chip that uses a well-known electric capacitance type detection method, in which a capacitive element or the like is provided on a semiconductor substrate (not shown in detail).

In the preformed part 11, the wiring terminal 112 is electrically connected to the physical quantity sensing element 111. In the present embodiment, in a surface of the physical quantity sensing element 111, a wiring (not shown) on a sensing surface 111a on which capacitive element or the like is provided and the wiring terminal 112 are connected to each other with a bonding wire 112a.

In the preformed part 11, an inner resin portion 113 has a concave portion 113a in which the gas to be measured is introduced. In detail, the concave portion 113a is configured that an opening area in the cross section parallel to the sensing surface 111a becomes gradually smaller toward the physical quantity sensing element 111. In the present embodiment, concretely, the concave portion 113a is formed in a truncated cone shape and is disposed so that a part of the sensing surface 111a is exposed at the bottom of the concave portion 113a. In addition, the concave portion 113a may be formed in a shape such as a truncated pyramidal shape such as a polygonal pyramid shape, a columnar shape, a polygonal column shape, or the like.

The inner resin portion 113 is molded around the physical quantity sensing element 111 and the wiring terminal 112 to be integral with the physical quantity sensing element 111 and the wiring terminal 112, in a state in which the sensing surface 111a of the physical quantity sensing element 111 is exposed at the concave portion 113a, fixes them, and protects them. The wiring terminal 112 is exposed at the surface in the side on the wiring member 12 of the preformed part 11 so as to be electrically connected to the wiring member 12. The bonding wire 112a for connecting the physical quantity sensing element 111 and the wiring terminal 112 is protected by being buried inside of the inner resin portion 113.

The wiring member 12 is electrically connected to the wiring terminal 112 of the preformed part 11. In the present embodiment, concretely, an electrical connecting portion 121 is constructed by electrically connected between the wiring member 12 and the wiring terminal 112 with a solder 120. In detail, the wiring member 12 is a printed board. The printed board may be a rigid board, or a flexible board, or a combination between the rigid board and the flexible board. In the present embodiment, the wiring member 12 is the rigid board. The rigid board is harder than the flexible board. Therefore, this configuration is advantageous for improving the strength of the physical quantity sensor subassembly 1 in addition to the resin molding effect by the outer resin portion 13. A terminal 122 is electrically connected to the wiring member 12.

The outer resin portion 13 has an opening hole portion 131 communicating with the concave portion 113a. The gas to be measured can be reached to the concave portion 113a through the opening hole portion 131. The opening hole portion 131 is provided adjacent to the concave portion 113a in order to be easily communicated with the concave portion 113a. In detail, the opening hole portion 131 is configured that an opening area in the cross section parallel to the sensing surface 111a becomes gradually smaller toward the physical quantity sensing element 111. If a side of the sensing surface 111a is located on lower side and a side of an introduction of the gas to be measured is located on upper side, the opening area on the lower side of the opening hole portion 131 can be larger than the opening area on the upper side of the opening hole portion 131. In this case, when the outer resin portion 13 is molded, the concave portion 113a of the preformed part 11 can be closed with a mold, and the outer resin portion 113 can be molded easily while maintaining the concave portion 113a without being closed by the outer resin portion 13.

In the present embodiment, specifically, the opening hole portion 131 is formed in a truncated cone shape. According to this configuration, since the corner portion is eliminated in the opening hole portion 131, concentration of stress is unlikely to occur at the time of use, and the strength of the physical quantity sensor subassembly 1 can be easily secured. Further, due to the tapered slope, the gas to be measured is easily guided to the concave portion 113a.

The outer resin portion 13 is molded around the preformed part 11, the wiring member 12, the electrical connecting portion 121 electrically connected between the preformed part 11 and the wiring member 12 to be integral with the preformed part 11, the wiring member 12, the electrical connecting portion 121, and fixes and protects them. In the present embodiment, in the surfaces of the wiring member 12, a surface on the mounting side of the preformed part 11, a front end surface, a base end surface, and a side end surface are covered with the outer resin portion 13. However, the lower part of the physical quantity sensor subassembly 1 shown in FIG. 1 is defined as the front end side, and the upper part thereof is defined as the base end side. That is, in the surfaces of the wiring member 12, a surface on an opposite side to a side on which the preformed part 11 is mounted is not covered with the outer resin portion 13, and is exposed to the outside. The wiring member 12 may be buried inside of the outer resin portion 13. The outer resin portion 13 are molded around a part of the terminal 121 connected to the wiring member 12 together with the wiring member 12.

The physical quantity sensor subassembly 1 can be manufactured, for example, by mounting the preformed part 11 which is resin molded in advance on the wiring member 12 and then further resin molding it to form the outer resin part 13.

According to the physical quantity sensor subassembly 1, the electrical connecting portion 121 connected between the preformed part 11 and the wiring member 12 is protected by the outer resin portion 13. Therefore, in the physical quantity sensor subassembly 1, it is possible to avoid the impurities, the water droplets, and the like contained in the gas to be measured from adhering to the electrical connecting portion 121, and the environmental resistance can be improved.

Further, the physical quantity sensor subassembly 1 does not need to perform resin potting. Therefore, the physical quantity sensor subassembly 1 can simplify the manufacturing process.

In addition, in the physical quantity sensor subassembly 1, the outer resin portion 13 can serve not only as protection of the electrical connecting portion 121 but also as a casing for holding the wiring member 12 on which the preformed part 11 is mounted. Therefore, the physical quantity sensor subassembly 1 can reduce the number of parts, since the casing becomes unnecessary. Therefore, in the physical quantity sensor subassembly 1, it is unnecessary to manufacture the casing, to assemble to the casing, and the like, the manufacturing process can also be simplified in this respect. Therefore, the physical quantity sensor subassembly 1 is advantageous in cost reduction.

### Second Embodiment

The physical quantity sensor subassembly in the second embodiment will be described with reference to FIG. 4. The reference numerals used in the second and subsequent embodiments, the same reference numerals as those used in the above-described embodiments represent the same constituent elements and the like as in the previous embodiment, unless otherwise specified.

As illustrated in FIG. 4, in the physical quantity sensor subassembly 1 of the present embodiment, the wiring member 12 is specifically a lead frame. A part of the wiring member 12 protrudes from the base end surface of the outer resin portion 13 and the other part thereof is buried inside of the outer resin portion 13. Other configurations are the same as those in the first embodiment.

In the physical quantity sensor subassembly 1 of the present embodiment, since the wiring member 12 can be fixed and protected like the first embodiment, the environmental resistance can be improved. In addition, the manufacturing process can be simplified, and the number of parts can be reduced.

### Third Embodiment

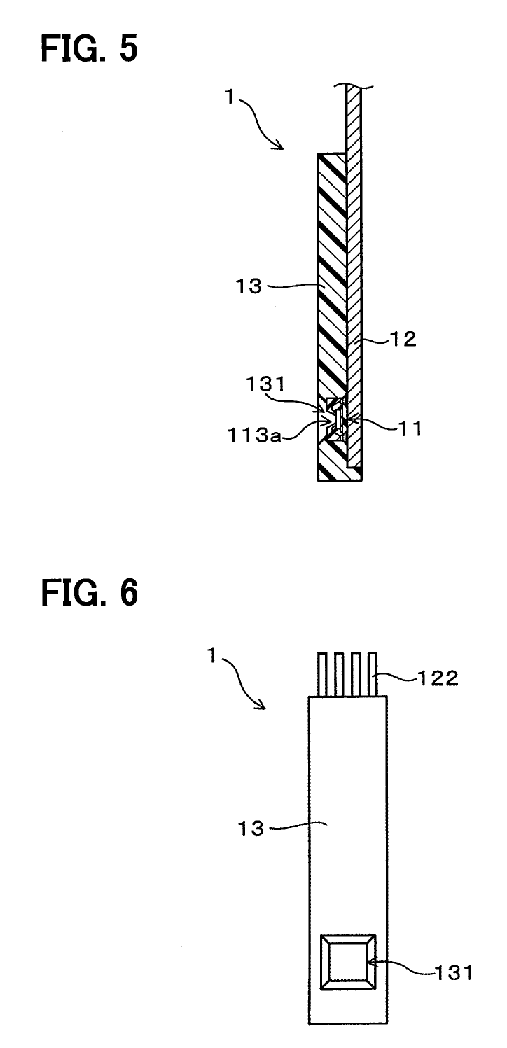

The physical quantity sensor subassembly in the third embodiment will be described with reference to FIG. 5.

As illustrated in FIG. 5, in the physical quantity sensor subassembly 1 of the present embodiment, the wiring member 12 is specifically the printed board, in more detail, the flexible board. In the present embodiment, the outer resin portion 13 is formed on a side of the top end of the wiring member 12. On the top end side of the wiring member 12, in the surfaces of the wiring member 12, the surface on the mounting side of the preformed part 11, the front end surface, and the side end surface are covered with the outer resin portion 13. That is, on the top end side of the wiring member 12, in the surfaces of the wiring member 12, a surface on an opposite side to a side on which the preformed part 11 is mounted is not covered with the outer resin portion 13, and is exposed to the outside. Other configurations are the same as those in the first embodiment.

In the physical quantity sensor subassembly 1 of the present embodiment, the environmental resistance can be improved, the manufacturing process can be simplified, and the number of parts can be reduced like the first embodiment.

### Fourth Embodiment

The physical quantity sensor subassembly in the fourth embodiment will be described with reference to FIG. 6.

As illustrated in FIG. 6, in the physical quantity sensor subassembly 1 of the present embodiment, the opening hole portion 131 is formed in a multi-angle truncated cone shape. Other configurations are the same as those in the first embodiment.

According to the physical quantity sensor subassembly 1 of the present embodiment, an opening amount of the opening hole portion 131 is easily increased in comparison with the first embodiment. Therefore, in this case, the gas to be measured is easily introduced in the concave portion 113a of the preformed part 11.

### Fifth Embodiment

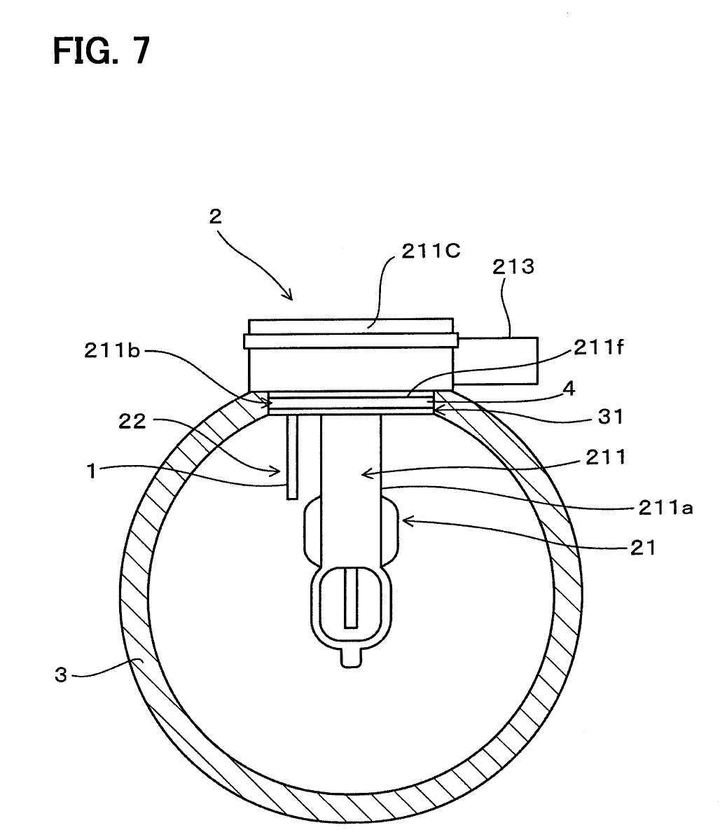

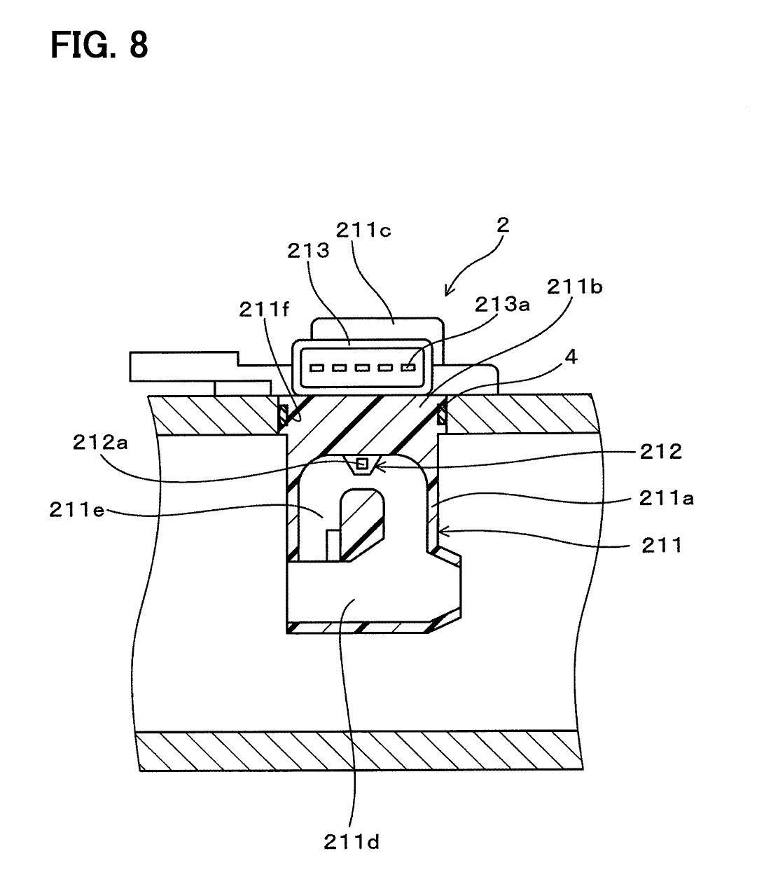

The physical quantity measuring device in the fifth embodiment will be described with reference to FIGS. 7 and 8. As illustrated in FIGS. 7 and 8, the physical quantity measuring device 2 of the present embodiment includes a flow rate measuring unit 21 that measures a flow rate of the gas to be measured, and a physical quantity measuring unit 22 that measures physical quantities other than the flow rate of the gas to be measured. The physical quantity measuring unit 22 includes a physical quantity sensor subassembly. In the present embodiment, the physical quantity sensor subassembly 1 of the first embodiment is applied.

Specifically, in the present embodiment, the physical quantity measuring device 2 is mounted on the gas flow path 3 through which the gas to be measured flows. The physical quantity measuring device 2 measures the flow rate of the gas to be measured by the flow rate measuring unit 21, and the humidity of the gas to be measured by the physical quantity measuring unit 22 respectively. Here, the gas passage 3 is an intake passage of the internal combustion engine (not shown), and the gas to be measured is the intake air. Further, the physical quantity measuring device 2 outputs data obtained by the measurement to an electronic control unit (ECU, not shown). The electronic control unit performs fuel injection control, addition control and the like based on the data relating to the flow rate and the humidity of the intake air as the gas to be measured obtained from the physical quantity measuring device 2.

In the present embodiment, the flow rate measuring unit 21 specifically includes a casing portion 211, a flow rate sensor 212, and a connector 211c.

The casing portion 211 specifically includes a bypass forming portion 211a, a fitting portion 211b, and an attachment portion 211c.

In the casing portion, the bypass forming portion 211a is a portion which protrudes into the tubular gas path 3. The bypass forming portion 211a has a bypass passage 211d bypassing the gas flow passage 3, and a sub bypass passage 211e further bypassing the bypass passage 211d inside of the bypass forming portion 211a. The bypass forming portion 211a is disposed in a state of protruding into the gas flow path 3 so as to be perpendicular to the flow of the gas to be measured in the gas flow path 3. The casing portion 211 can be configured, for example, by joining two resin parts having planar symmetry.

In the casing portion 211, the fitting portion 211b is a portion which fixes to an insertion opening 31 formed on the flow path wall of the gas flow path 3. In the present embodiment, the fitting portion 211b is formed in a cylindrical shape, and on the outer peripheral surface thereof an annular groove 211f in which the O ring 4 fits is formed.

In the casing portion 211, the attachment portion 211c is a portion which is fastened to the flow path wall of the gas flow path 3 with a fastening member, such as a screw.

The flow rate sensor 212 has a flow rate sensing element 212a for detecting the flow rate of the gas to be measured. The flow rate sensing element 212a has a chip shape. More specifically, the flow rate sensing element 212a is provided with a heating resistor element, a temperature sensitive resistor element, and the like on a semiconductor substrate (not shown in detail), and a sensor chip using a known thermal detection method. The flow rate sensor 212 is held by the bypass forming portion 211a and protrudes into the gas flow path 3 so as to be perpendicular to the flow of the gas to be measured in the gas flow path 3. The flow rate sensing element 212a is arranged in the sub-bypass passage 211e.

The connector 213 outputs a signal corresponding to the flow rate of the gas to be measured, and a physical quantity (such as humidity) other than the flow rate of the gas to be measured to the outside (electronic control unit or the like). The connector 213 supplies electrical power to the flow rate sensor 212, and the physical quantity sensor subassembly 1. The connector 213 is formed integrally with the casing portion 211. Each of the flow rate sensor 212 and the physical quantity sensor subassembly 1 is electrically connected to the connector terminal 213a provided in the connector 213.

Specifically, the physical quantity sensor subassembly 1 in the physical quantity measuring unit 22 is provided so as to protrude into the gas flow path 3 through which the gas to be measured flows, when the physical quantity measuring device 2 is attached to the gas flow path 3. Therefore, when the physical quantity measuring device 2 is attached to the gas flow path 3, the physical quantity sensor subassembly 1 is disposed in a state of protruding into the gas flow path 3. Specifically, the physical quantity sensor subassembly 1 can be, for example, arranged so as to protrude into the gas flow path 3 in a state perpendicular to the flow of the gas to be measured in the gas flow path 3 and to be separated from the casing portion 211.

According to the physical quantity measuring device 2 of the present embodiment, since the environmental resistance can be improved by the physical quantity sensor subassembly 1 of the present embodiment, the flow rate of the gas to be measured and the physical quantity other than the flow rate of the gas to be measured can be accurately measured. Further, the physical quantity measuring device 2 of the present embodiment can simplify the manufacturing process and reduce the number of parts.

The present disclosure is not limited to each of the above described embodiments, and can be applied to various embodiments without departing from the gist thereof. That is, although the present disclosure is described in accordance with the embodiments, it is understood that the present disclosure is not limited to the embodiments, structures, and the like. The present disclosure encompasses various modifications and variations within the equivalent scope. In addition, various combinations and forms, as well as other combinations and forms which include only one element, more than that, or less, are also within the scope and idea of the present disclosure.

In the above mentioned embodiments, one example in which the physical quantity relating to the intake air flowing in the intake passage of the internal combustion engine is measured is illustrated. Besides this example, the above mentioned physical quantity sensor subassembly 1 and the physical quantity measuring device 2 may measure the physical quantity regarding the exhaust gas flowing in the exhaust gas passage of the internal combustion engine and the like.

Further, the physical quantity sensor subassembly 1 can have, for example, a filter (not shown) covering the concave portion 113a of the preformed part 11. In this case, the gas to be measured is introduced into the concave portion 113a after passing through the filter. Therefore, the impurities, the water droplets, and the like contained in the gas to be measured are removed by the filter, so that these can be prevented from adhering to the sensing surface 111a of the physical quantity sensing element 111. Therefore, according to this configuration, it is possible to obtain the physical quantity sensor subassembly 1 and the physical quantity measuring device 2 which are easy to detect the physical quantity with high accuracy. The filter can be provided so as to cover the concave portion 113a, for example, in a state of being separated from the sensing surface 111a. Further, the outer peripheral edge of the filter can be, for example, buried inside of the outer resin portion 13. Examples of the material of the filter include ceramics, resin, metal and the like.

The opening hole portion 131 of the physical quantity sensor subassembly 1 may be formed not only in the shape of a truncated cone or a polygonal pyramid, but also in the shape of a cylinder or a polygonal prism.

Further, in the physical quantity measuring device 2 of the fifth embodiment, the example using the physical quantity sensor subassembly 1 of the first embodiment is shown. The physical quantity measuring device 2 of the fifth embodiment may include the physical quantity sensor subassembly 1 of the second to fourth embodiments instead of the physical quantity sensor subassembly 1 of the first embodiment.

1. A physical quantity sensor subassembly, comprising:
a preformed part including a physical quantity sensing element configured to detect a physical quantity other than a flow rate of gas to be measured, a wiring terminal electrically connected to the physical quantity sensing element, a concave portion in which the gas to be measured is introduced, and an inner resin portion which is molded around the physical quantity sensing element and the wiring terminal to be integral with the physical quantity sensing element and the wiring terminal, wherein a sensing surface of the physical quantity sensing element is exposed at the concave portion; and
an outer resin portion including a wiring member electrically connected to the wiring terminal of the preformed part, and an opening hole portion communication with the concave portion, wherein
the outer resin portion is molded around the preformed part, the wiring member, and an electrically connecting portion between the preformed part and the wiring member to be integral with the preformed part, the wiring member, and the electrically connecting portion.

2. The physical quantity sensor subassembly according to claim 1, wherein
the physical quantity is at least one selected from a group consisting of humidity, temperature, and pressure.

3. The physical quantity sensor subassembly according to claim 1, wherein
the wiring member is at least one selected from a group consisting of a printed board, a lead frame, and a bus bar.

4. The physical quantity sensor subassembly according to claim 1, wherein
the opening hole portion is formed in a truncated cone shape, or a polygonal pyramid shape.

5. The physical quantity sensor subassembly according to claim 1, wherein
an opening area on a lower side of the opening hole portion is larger than the opening area on an upper side of the opening hole portion.

6. A physical quantity measuring device, comprising:
a flow rate measuring portion configured to measure a flow rate of gas to be measured; and
a physical quantity measuring portion configured to measure a physical quantity other than the gas to be measured; wherein the physical quantity measuring portion includes a physical quantity sensor subassembly according to claim 1.

7. The physical quantity measuring device according to claim 6, wherein
the physical quantity sensor subassembly is provided to protrude in a gas flow path in which the gas to be measured flows.
